(19) United States
(12) Patent Application Publication
(10) Pub. No.: US 2025/0309448 A1
(43) Pub. Date: Oct. 2, 2025

(54) MODULAR BATTERY ASSEMBLY

(71) Applicants: CPS Technology Holdings LLC, New York, NY (US); Clarios Advanced Solutions GmbH, Hannover (DE)

(72) Inventors: Nicholas E. ELISON, Mequon, WI (US); Christopher M. BONIN, South Milwaukee, WI (US); Joerg BIRKHOLZ, Sarstedt (DE); Marco JANSEN, Celle/Groß Hehlen (DE); Ken NAKAYAMA, Racine, WI (US)

(21) Appl. No.: 18/861,632

(22) PCT Filed: May 2, 2023
(86) PCT No.: PCT/US2023/020699

§ 371 Date: Oct. 30, 2024

Related U.S. Application Data
(60) Provisional application No. 63/337,343, filed on May 2, 2022.

(51) Int. Cl. H01M 50/258; H01M 10/42; H01M 10/48; H01M 50/213; H01M 50/244; H01M 50/264; H01M 50/271; H01M 50/284; H01M 50/367; H01M 50/507; H01M 50/516

(52) U.S. Cl. CPC H01M 50/258; H01M 10/4257; H01M 10/486; H01M 50/213; H01M 50/244; H01M 50/264; H01M 50/271; H01M 50/284; H01M 50/367; H01M 50/507; H01M 50/516; H01M 2010/4271

(57) ABSTRACT

A method of manufacturing a battery assembly including sliding each of a plurality of battery cells into a cavity of a first plurality of cavities of a first panel of a cell stack. Each of the plurality of battery cells has a battery circumference and each cavity has a first end and a second end opposite the first end. The method further includes affixing a second cell stack panel to the first cell stack panel to form a cell stack. The second panel has a second plurality of cavities with a first end and a second end opposite the first end. The first end of each of the second plurality of cavities is aligned to the first end of a respective cavity of the first plurality of cavities.

### TECHNICAL FIELD

This disclosure relates to batteries and in particular to a modular battery assembly and system and method of manufacture of such an assembly and system.

### BACKGROUND

As battery technology evolves, the demand for improved power sources such as energy storage modules for vehicles continues to grow. Existing battery systems typically require expensive epoxies and also typically requires complex and expensive processes for ensuring the sub-components of the battery system fit together.

Thus, existing systems lack configurations for supporting modular battery assemblies and methods for manufacturing of same.

### SUMMARY

As battery technology evolves, there is a need to provide improved power sources, and more efficient and cost-effective methods for manufacturing such power sources as compared to conventional systems and methods.

Accordingly, embodiments described herein provide a battery system and assembly which overcomes the disadvantages of conventional arrangements, and which at the same time are easy to manufacture, economical and versatile as compared with conventional arrangements. The embodiments described herein can be adapted and assembled, while meeting the specific demands posed by modern battery chemistries, such as lithium-ion battery chemistries. Embodiments described herein provide a method for assembling such a battery, in an efficient and cost efficient manner.

The present invention provides for a device, method, and system for a battery assembly. In accordance with one aspect, the battery assembly includes a battery housing including a housing cavity. A cell stack is disposed within the housing cavity, in which the cell stack includes a first cell stack panel including a first inner surface and a first outer surface, and a second cell stack panel including a second inner surface and a second outer surface. The first cell stack panel and the second cell stack panel are coupled together at the respective first and second inner surfaces. The coupling of the second cell stack panel and the first cell stack panel form a plurality of cavities, each of the plurality of cavities extending from the first outer surface to the second outer surface. A plurality of battery cells are each disposed within a respective cavity of the plurality of cavities. A plurality of bus bars are each electrically coupled to at least one of a positive terminal and a negative terminal of at least one battery cell.

In some embodiments, at least one of the plurality of cavities includes a venting region (also referred to as a venting cavity). In some embodiments, an inner bottom surface of the housing cavity includes a first plurality of interlocking features. A bottom surface of the cell stack includes a second plurality of interlocking features. The first plurality of interlocking features of the inner bottom surface of the housing cavity are coupled to the second plurality of interlocking features of the bottom surface of the cell stack. In some embodiments, the first plurality of interlocking features includes at least one of guiding ribs and interlocking circular features. In some embodiments, the second plurality of interlocking features includes at least one of guiding ribs and interlocking circular features. In some embodiments, the plurality of bus bars includes at least one copper bus bar and at least one nickel-plated steel bus bar. In some embodiments, the first plurality of interlocking features is coupled by an adhesive to the second plurality of interlocking features, the adhesive being at least one of a gap-filling epoxy and a structural adhesive. In some embodiments, the cell stack includes a top surface, and the battery assembly further includes a battery management unit, BMU, affixed to the top surface of the cell stack. In some embodiments, each of the plurality of battery cells is a cylindrical battery cell. In some embodiments, each of the plurality of cavities is a cylindrical cavity.

The present invention provides for a method for manufacturing a battery system, the method including sliding each of a plurality of battery cells into a respective cavity of a first plurality of cavities of a first panel of a cell stack, each of the plurality of battery cells having a battery circumference, each cavity of the first plurality of cavities having a first end with a circumference at least as large as the battery circumference and a second end opposite the first end with a circumference smaller than the battery circumference, affixing a second cell stack panel to the first cell stack panel to form a cell stack, the second panel having a second plurality of cavities, each of the second plurality of cavities having a first end with a circumference at least as large as the battery circumference and a second end opposite the first end with a circumference smaller than the battery circumference, and the first end of each of the second plurality of cavities being aligned to a respective first end of a respective cavity of the first plurality of cavities, and affixing a battery management unit, BMU, to a first surface of the cell stack.

In some embodiments, the method further includes applying an adhesive to a first plurality of interlocking features of an inner surface of a cavity of a battery housing, and inserting the cell stack into the battery housing. A second surface of the cell stack panel is aligned to the inner surface of the cavity of the battery housing. The second surface of the cell stack panel includes a second plurality of interlocking features aligned to the first plurality of interlocking features using an adhesive. The adhesive is at least one of a gap-filling epoxy and a structural adhesive.

In some embodiments, the first plurality of interlocking features includes at least one of guiding ribs and interlocking circular features. In some embodiments, the second plurality of interlocking features includes at least one of guiding ribs and interlocking circular features. In some embodiments, the method further includes affixing a first plurality of bus bars to a surface of the first cell stack panel. Each of the first plurality of bus bars includes a plurality of plates and a pad connector. The method further includes affixing a second plurality of bus bars to a surface of the second cell stack panel. Each of the second plurality of bus bars includes a plurality of plates and a pad connector. For each bus bar of the first plurality of bus bars, the method further includes welding each of the plates of the bus bar to at least one of a positive terminal and a negative terminal of at least one of the plurality of battery cells via the second end of a respective cavity of the first plurality of cavities. For each bus bar of the second plurality of bus bars, the method further includes welding each of the plates of the bus bar to at least one of a positive terminal and a negative terminal of at least one of the plurality of battery cells via the second end of a respective cavity of the second plurality of cavities. For each bus bar of the first plurality of bus bars, the method further includes welding the pad connector of the bus bar to a respective pad of the BMU. For each bus bar of the second plurality of bus bars, the method further includes welding the pad connector of the bus bar to a respective pad of the BMU.

In some embodiments, the method further includes affixing a lid to the first surface of the cell stack. The lid includes an inner surface, an outer surface, and an aperture through the lid from the outer surface to the inner surface. The method further includes coupling the inner surface of the lid to a rubber gasket of a BMU connector port disposed on the BMU. The rubber gasket is sized to seal the aperture. In some embodiments, each of the plurality of battery cells is a cylindrical battery cell. In some embodiments, each of the plurality of cavities is a cylindrical cavity.

According to a first embodiment of the present disclosure, a battery assembly is provided. The battery assembly includes a battery housing including a housing cavity, and a cell stack disposed within the housing cavity. The cell stack includes a first cell stack panel including a first inner surface and a first outer surface, a second cell stack panel including a second inner surface and a second outer surface, the first cell stack panel and the second cell stack panel being coupled together at the respective first and second inner surfaces, the coupled first cell stack panel and the second cell stack panel forming a plurality of cavities, each of the plurality of cavities extending from the first outer surface to the second outer surface, and a plurality of battery cells, each of the plurality of battery cells being disposed within a respective cavity of the plurality of cavities.

According to one or more embodiments of this aspect, the battery assembly further includes a plurality of bus bars, each bus bar of the plurality of bus bars being electrically coupled to at least one of a positive terminal and a negative terminal of at least one battery cell via at least one aperture in at least one of the first outer surface and the second outer surface.

According to one or more embodiments of this aspect, each of the plurality of battery cells is disposed perpendicularly to the first cell stack panel and the second cell stack panel.

According to one or more embodiments of this aspect, a first cavity of the plurality of cavities includes a venting region adjoining the first outer surface for venting a first battery cell of the plurality of battery cells.

According to one or more embodiments of this aspect, an inner bottom surface of the housing cavity includes a first plurality of interlocking features, and a bottom surface of the cell stack includes a second plurality of interlocking features, the first plurality of interlocking features being coupled to the second plurality of interlocking features to aid in securing the cell stack to the housing cavity.

According to one or more embodiments of this aspect, the first plurality of interlocking features is coupled by an adhesive to the second plurality of interlocking features, the adhesive being at least one of a gap-filling epoxy and a structural adhesive.

According to one or more embodiments of this aspect, the battery assembly further includes a top cover including a top aperture and an inner surface, and a battery management unit, BMU, affixed to a top surface of the cell stack, the BMU including a connector port for providing power to an external device, and a gasket sealed to the inner surface of the top cover when the connector port is disposed through the top aperture.

According to one or more embodiments of this aspect, the battery assembly further includes a temperature sensor, the temperature sensor including a first end and a second end, the first end being compressed against a first surface of a first battery cell of the plurality of battery cells and the second end being affixed to the BMU.

According to one or more embodiments of this aspect, the top cover is affixed to the battery housing and to the cell stack.

According to one or more embodiments of this aspect, each of the plurality of battery cells is a cylindrical battery cell, each of the plurality of battery cells having a battery circumference and a battery length, each of the plurality of cavities being a cylindrical cavity, each of the plurality of cavities having a first end at the first outer surface with a circumference smaller than the battery circumference, a second end at the second outer surface with a circumference smaller than the battery circumference, and a portion between 10 the first outer surface and the second outer surface with a circumference at least as large as the battery circumference and with a length approximately equal to the battery length.

According to another aspect of the present disclosure, a method of manufacturing a battery assembly is provided. The method includes placing each of a plurality of battery cells into a respective cavity of a first plurality of cavities of a first cell stack panel of a cell stack, the first cell stack panel having a first inner surface and a first outer surface, each of the plurality of battery cells having a battery circumference, each of the first plurality of cavities having a first end at the first inner surface with a circumference at least as large as the battery circumference and a second end at the first outer surface with a circumference smaller than the battery circumference. The method further includes affixing a second cell stack panel to the first cell stack panel to form a cell stack, the second cell stack panel having a second plurality of cavities, the second cell stack panel having a second inner surface and a second outer surface, each of the second plurality of cavities having a first end at the second inner surface with a circumference at least as large as the battery circumference and a second end at the second outer surface with a circumference smaller than the battery circumference, the first end of each of the second plurality of cavities being aligned to a respective first end of a respective cavity of the first plurality of cavities, and the first inner surface being aligned to the second inner surface. The method further includes affixing a battery management unit, BMU, to a first surface of the cell stack, and inserting the cell stack into a battery housing.

According to one or more embodiments of this aspect, the method further includes applying an adhesive to a first plurality of interlocking features of an inner surface of a cavity of the battery housing, and inserting the cell stack into the battery housing such that a second surface of the cell stack is aligned to the inner surface of the cavity of the battery housing, the second surface of the cell stack including a second plurality of interlocking features aligned to the first plurality of interlocking features using the adhesive, the adhesive being at least one of a gap-filling epoxy and a structural adhesive.

According to one or more embodiments of this aspect, the first plurality of interlocking features includes at least one of guiding ribs and interlocking circular features, and the second plurality of interlocking features includes at least one of guiding ribs and interlocking circular features.

According to one or more embodiments of this aspect, the method further includes affixing a first plurality of bus bars to a surface of the first cell stack panel, each of the first plurality of bus bars including a plurality of plates and a pad connector, affixing a second plurality of bus bars to a surface of the second cell stack panel, each of the second plurality of bus bars including a plurality of plates and a pad connector for each bus bar of the first plurality of bus bars, welding each of the plates of the bus bar to at least one of a positive terminal and a negative terminal of at least one of the plurality of battery cells via the second end of a respective cavity of the first plurality of cavities, for each bus bar of the second plurality of bus bars, welding each of the plates of the bus bar to at least one of a positive terminal and a negative terminal of at least one of the plurality of battery cells via the second end of a respective cavity of the second plurality of cavities, for each bus bar of the first plurality of bus bars, welding the pad connector of the bus bar to a respective pad of the BMU, and for each bus bar of the second plurality of bus bars, welding the pad connector of the bus bar to a respective pad of the BMU.

According to one or more embodiments of this aspect, the method further includes affixing a top cover to the first surface of the cell stack, the top cover including an inner surface, an outer surface, and an aperture through the top cover from the outer surface to the inner surface, and coupling the inner surface of the top cover to a gasket of a connector port disposed on the BMU, the gasket being sized to seal the aperture when the connector port is disposed through the aperture.

According to one or more embodiments of this aspect, the method further includes affixing the top cover to the battery housing and to the cell stack.

According to one or more embodiments of this aspect, each of the plurality of battery cells is a cylindrical battery cell with a corresponding battery length, each of the first and second plurality of cavities being a cylindrical cavity of approximately half the corresponding battery length.

According to one or more embodiments of this aspect, each of the plurality of battery cells is disposed perpendicularly to the first cell stack panel and the second cell stack panel.

According to one or more embodiments of this aspect, a first cavity of the first plurality of cavities includes a venting region adjoining the first outer surface.

According to one or more embodiments of this aspect, the method further includes affixing a temperature sensor to the battery assembly, the temperature sensor including a first end and a second end, the first end being compressed against a first surface of a first battery cell of the plurality of battery cells and the second end being affixed to the BMU.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a perspective of an example battery assembly, in accordance with an aspect of the present disclosure;

FIG. 2 is an exploded view of the battery assembly of FIG. 1, in accordance with an aspect of the present disclosure;

FIG. 3 is an exploded view of a battery cell stack, in accordance with an aspect of the present disclosure;

FIG. 4 is a perspective view of the battery cell stack of FIG. 3, in accordance with an aspect of the present disclosure.

FIG. 5 is a perspective view of a portion of the battery cell stack of FIG. 3, in accordance with an aspect of the present disclosure;

FIG. 6 is a cutaway perspective view of a portion of the battery cell stack of FIG. 3, in accordance with an aspect of the present disclosure;

FIG. 7 is a close-up of a portion of the cutaway perspective view of FIG. 6, in accordance with an aspect of the present disclosure;

FIG. 8 is a perspective view of the bottom surface of the battery cell stack of FIG. 3, in accordance with an aspect of the present disclosure;

FIG. 9 is a perspective view of the battery housing, in accordance with an aspect of the present disclosure;

FIG. 10 is a cutaway perspective view of the battery assembly of FIG. 1, in accordance with an aspect of the present disclosure;

FIG. 11 is a flowchart of an example method of assembling a battery assembly according to one or more embodiments of the invention; and

FIG. 12 is a flowchart of another example method of assembling a battery assembly according to one or more embodiments of the invention.

### DETAILED DESCRIPTION

Before describing in detail exemplary embodiments, it is noted that the embodiments reside primarily in combinations of apparatus components and manufacturing steps related to a battery assembly. Accordingly, the apparatus and method components have been represented where appropriate by conventional symbols in the drawings, showing only those specific details that may be pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” may be intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations may be possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Generally, the disclosed embodiments may be directed toward a battery assembly and/or system, and method of manufacturing a battery assembly and/or system which reduces or eliminates the need for expensive epoxies, is readily scalable, and allows for proper venting of the battery cells within the assembly. Such battery assemblies may be used, for example, as auxiliary batteries for vehicles, although they are not so limited, and may be applicable to any application that requires a battery assembly.

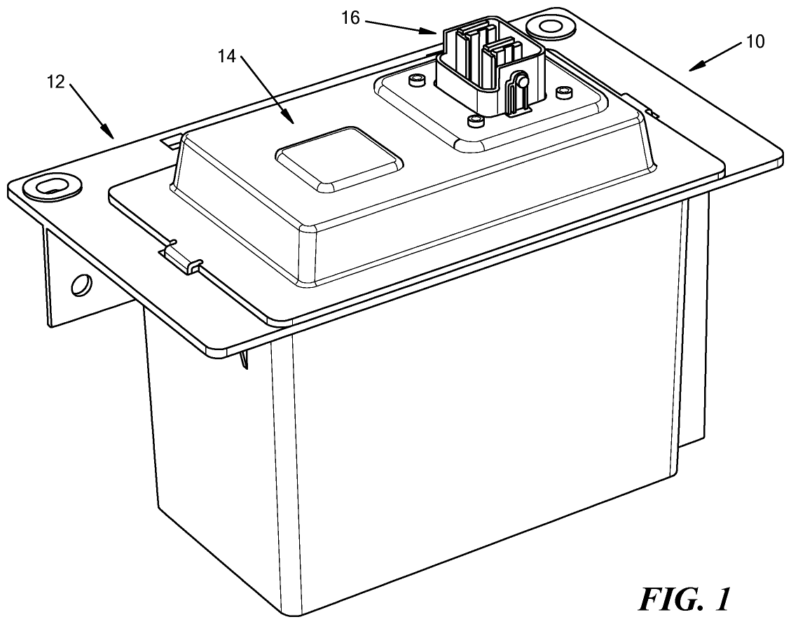

Referring to the drawing figures, in which like elements may be referred to by like reference numerals, there is shown in FIG. 1 a diagram of battery assembly 10, according to an embodiment, which includes a battery housing 12 and a (battery cell stack) lid 14 affixable to the battery housing 12. A connector port 16 is configured to communicate power and/or data with external equipment, such electronically in a vehicle in communication with the battery assembly 10.

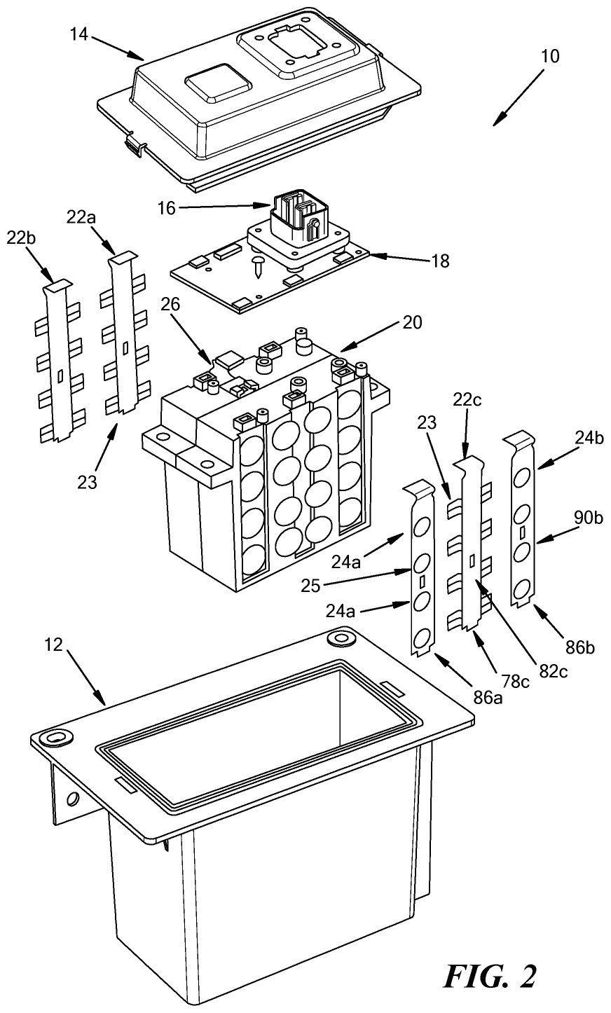

Example embodiments of the battery assembly 10 discussed in the preceding paragraphs will now be described in FIG. 2, which is an exploded view of the battery assembly 10 of FIG. 1. As depicted, battery assembly 10 may include a battery cell stack lid 14, a battery management unit (BMU) 18 that is configured to perform one or more battery management functions, connector port 16 of BMU 18, battery cell stack 20, nickel-plated steel bus bars 22a-c and copper bus bars 24a-b coupled to battery cell stack 20, temperature sensor 26 coupled to battery cell stack 20, and battery housing 12. Each of bus bars 22a-c may have a plurality of battery connector members 23. Each of bus bars 24a-b may have a plurality of battery connector members 25. A temperature sensor 26 may be affixed to battery cell stack 20. The battery housing 12 may include a number (e.g., four) of walls defining a housing cavity for receiving the battery cell stack 20, the battery cell stack lid 14, the BMU 18, the temperature sensor 26, and the bus bars 22a-c and 24a-b.

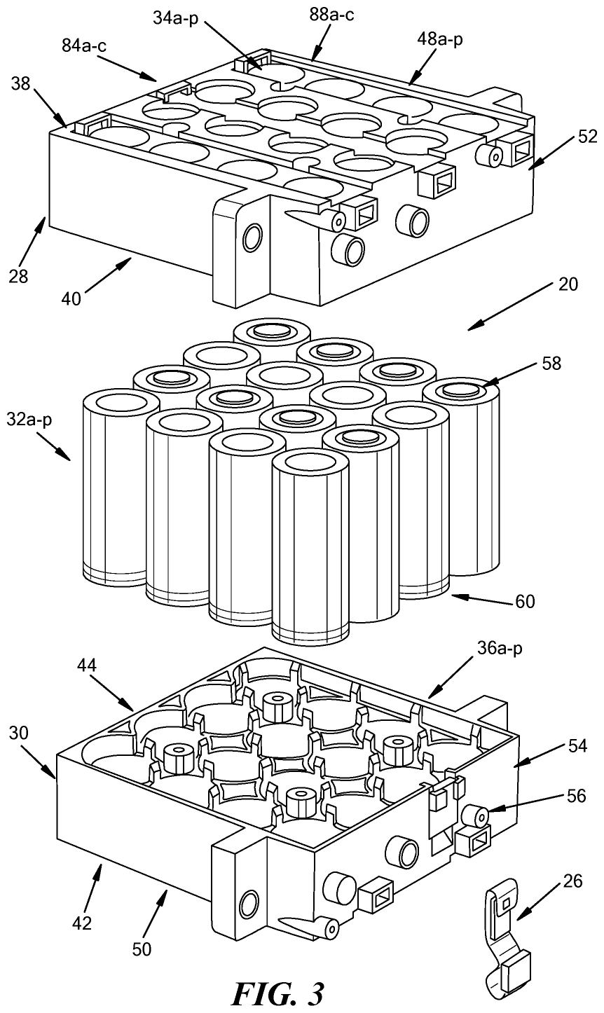

A more detailed, exploded view of the battery cell stack 20 is shown in FIG. 3. The battery cell stack 20 may include an upper cell stack panel 28, a bottom cell stack panel 30, and sixteen battery cells 32a-p (collectively, battery cells 32), although any number of battery cells may be used in an amount and configuration so as to have a sufficient energy density, voltage, current, capacity, and so forth, for a particular application. Also, although the battery cells 32 are shown as cylinders, it is understood that the battery cells 32 may have other geometric configurations, e.g., rectangular prism, etc. Upper cell stack panel 28 may include sixteen cavities 34a-p (collectively, cavities 34), i.e., at least one for each battery cell 32. Bottom cell stack panel 30 may include sixteen cavities 36a-p (collectively, cavities 36), i.e., one for each battery cell 32. In some embodiments, each of the battery cells 32 may have a cylindrical shape with a circumference configured to be the same as or slightly smaller than the circumference of each of the cylindrical cavities 34 and 36, such that the cylindrical battery cells 32 fit securely into the cylindrical cavities 34 and 36, with sufficient room to account for variations caused by temperature changes, manufacturing conditions, etc. In the example shown in FIG. 3, the battery cells 32 and the cavities 34 and 36 are a cylindrical shape, but any shape of battery cell and cavity may be used without deviating from the scope of the invention. In some embodiments, for example, the shape of each battery cell is similar to the shape of each corresponding cavity, with the cavity being sized equal to or slightly larger than the shape of the battery cell so that the battery cell fits securely within the cavity. The upper cell stack panel 28 may have an outer surface 38 opposite an inner surface 40, with the cavities 34 arranged perpendicularly to the plane of outer surface 38 and the plane of inner surface 40. Similarly, bottom cell stack panel 30 may have an outer surface 42 opposite an inner surface 44, with the cavities 36 arranged perpendicularly to the plane of outer surface 42 and the plane of inner surface 44. The inner surface 40 of upper cell stack panel 28 may be configured to couple with the inner surface 44 of bottom cell stack panel 30.

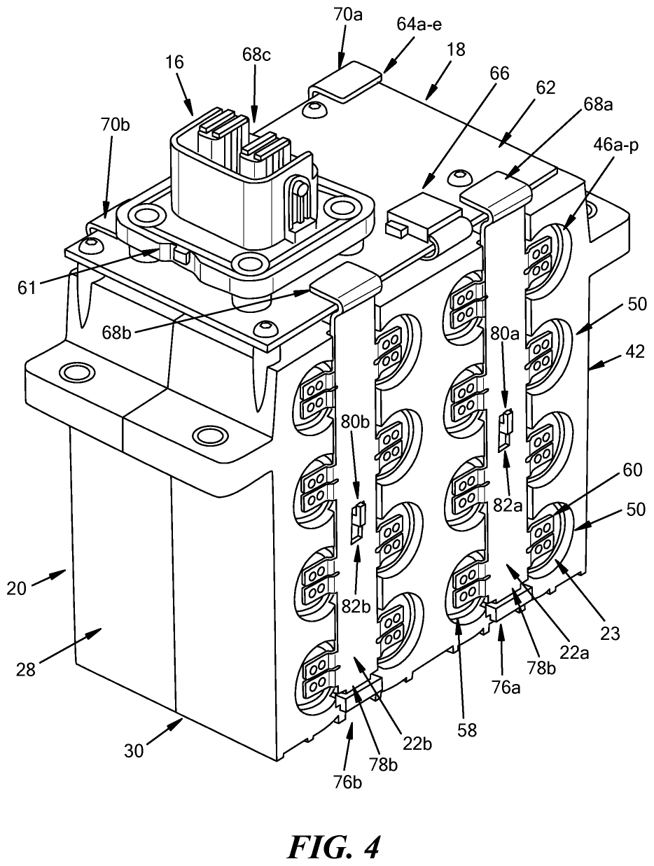

Still referring to FIG. 3, cavities 34 and 36 may be distributed in a similar pattern across upper cell stack panel 28 and bottom cell stack panel 30, respectively, such that, when the upper cell stack panel 28 and bottom cell stack panel 30 are coupled together at their inner surfaces 40 and 44, cavities 34 line up with cavities 36 to form cavities 46a-p (shown in FIG. 4) (collectively, cavities 46). The length of the battery cells 32 may be configured to be substantially the same as or slightly less than the length of cavities 46, such that, when the upper cell stack panel 28 and bottom cell stack panel 30 are coupled together at their inner surface 40 and 44 to form cavities 46, the length of each of cavities 46 is substantially the same as or slightly more than the length of the battery cells 32, such that each battery cell 32 is securely housed in a respective cavity 46.

Still referring to FIG. 3, the outer surface 38 of upper cell stack panel 28 may include sixteen apertures 48a-p (collectively, apertures 48) defined by circular sections of the outer surface 38 corresponding to the outer end of the cavities 34. The circumference of each of the (circular) apertures 48 may be at most slightly less than the circumference of each of the battery cells 32, such that when the battery cells 32 may be placed in the cavities 34 via the inner surface 40 of the upper cell stack panel 28, the battery cells 32 are retained within corresponding cavities 34. Similarly, the outer surface 42 of bottom cell stack panel 30 may include sixteen circular apertures 50a-p (collectively, circular apertures 50) defined by circular sections of the outer surface 42 corresponding to the outer end of cavities 36. The circumference of each of the circular apertures 50 is at most slightly less than the circumference of each of the battery cells 32, such that when the battery cells 32 may be placed in the cavities 36 via the inner surface 44 of the bottom cell stack panel 30, the battery cells 32 are retained within corresponding cavities 36. Although, in the above example, circular apertures 48a-p are described as circular, the apertures 48a-p may be any shape without deviating from the scope of the present disclosure.

Still referring to FIG. 3, upper cell stack panel 28 may include surface 52, and bottom cell stack panel 30 may include surface 54. Upper cell stack panel 28 and bottom cell stack panel 30 may be of similar shape and dimensions. Upper cell stack panel 28 and bottom cell stack panel 30 may be coupled together at inner surface 40 and inner surface 44, and surface 52 of the upper cell stack panel 28 may be coupled to surface 54 of the bottom cell stack panel 30 to form top surface 55. The coupling may be achieved using screws, adhesives, and/or other suitable affixation technique known in the art. Top surface 55 may include screw holes and/or other elements for assembling the (top) surface 55 to the cell stack lid 14 (shown in FIG. 2) and/or BMU 18 and/or any other component in the assembly. Top surface 55 of bottom cell stack panel 30 may include a receptacle 56 configured to retain temperature sensor 26 in place.

Still referring to FIG. 3, each of the battery cells 32a-p may include a positive terminal end 58a-p (collectively, positive terminal ends 58) and a negative terminal end 60a-p (collectively, negative terminal ends 60). The battery cells 32 may be arranged in a grid arrangement, in which the orientation of the terminals of the battery cells varies on a row-by-row basis or column-by-column basis. For example, battery cells 32a-d in row 1 may be arranged with the positive terminal ends 58a-d oriented to face the circular apertures 48a-d of upper cell stack panel 28, while battery cells 32e-h in row 2 may be arranged with the negative terminal ends 60e-h oriented to face the circular apertures 48e-h of upper cell stack panel 28. Other patterns and/or orientations may be used without deviating from the scope of the present disclosure. Furthermore, in the above examples, sixteen battery cells 32 are stored in sixteen cavities 46, but a variety of quantities of battery cells 32 and/or cavities 46 may be used without deviating from the scope of the present disclosure. Further, the number of battery cells 32 may be equal to or fewer than the number of cavities 46.

FIG. 4 is a perspective view of assembled battery cell stack 20. Upper cell stack panel 28 and bottom cell stack panel 30 may be of similar shape and dimensions, or may have different shapes and dimensions, so long as cavities 34 are aligned with cavities 36 when upper cell stack panel 28 and bottom cell stack panel 30 are affixed together. Upper cell stack panel 28 and bottom cell stack panel 30 may be affixed together at inner surface 40 and inner surface 44, and surface 52 of the upper cell stack panel 28 may be affixed to surface 54 of the bottom cell stack panel 30 to form top surface 55. The affixing may be achieved using adhesives, screws, and/or any other suitable assembly technique known in the art. The coupling may be reversible, e.g., to allow for servicing, replacement, and/or recycling of the battery cells 32.

Still referring to FIG. 4, BMU 18, including circuit board 62 and connector port 16, may be coupled to top surface 55. Connector port 16 may include a gasket 61 disposed around the perimeter of connector port 16. Gasket 61 may be formed of rubber and/or some other suitable material for sealing. Circuit board 62 may include pads 64a-e (collectively, pads 64) (e.g., at least one pad for each of bus bars 22a-c and at least one pad for each of bus bars 24a-b) and temperature sensor port 66. In some embodiments, circuit board 62 may be a printed circuit board. In some embodiments, the BMU 18 may include one or more controllers, one or more processors, processing circuitry, one or more memory devices, and/or one or more internal/external signal connectors disposed on the circuit board 62. In some embodiments, the BMU may include multiple circuit boards 62.

Still referring to FIG. 4, each of bus bars 22a-b and 22c (shown in FIG. 2) may have a top end 68a-c formed perpendicular to the body of the bus bar 22a-c. Similarly, each of bus bars 24a-b (shown in FIG. 2) may have a top end 70a-b perpendicular to the body of the bus bar 24a-b. Each of top ends 68a-b and 68c and top ends 70a-b may be coupled to a corresponding pad 64a-e of the circuit board 62.

Still referring to FIG. 4, each of bus bars 24a-b (shown in FIG. 2) may have a plurality of battery connector members 25 shown in FIG. 2. Battery connector members 25 may be coupled to the positive terminals 58 and/or negative terminals 60 of each of the battery cells 32 via (circular) apertures 48 or (circular) apertures 50. Similarly, each of bus bars 22a-c may have a plurality of battery connector members 23. Battery connector members 23 may be coupled to the positive terminals 58 or negative terminals 60 of each of the battery cells 32 via apertures 48 (shown in FIG. 3 as circular apertures, as an example) or apertures 50 (which may also, for example, be circular apertures). For the sake of simplicity, positive terminals 58 and negative terminals 60 are also referred to herein as positive terminal 58 and negative terminal 60.

Still referring to FIG. 4, bottom cell stack panel 30 may include bus bar receptacles 76a-b into which bottom ends 78a-b of bus bars 22a-b may be inserted for securely holding bus bars 22a-b in place on the outer surface 42 of bottom cell stack panel 30. Outer surface 42 of bottom cell stack panel 30 may include hooks 80a-b which may be coupled to the bus bars via holes 82a-b in bus bars 22a-b for securely holding bus bars 22a-b in place on the outer surface 42 of bottom cell stack panel 30. Similarly, upper cell stack panel 28 may include bus bar receptacles 84a-c (shown in FIG. 3) into which bottom ends 86a-b (shown in FIG. 2) of bus bars 24a-b (shown in FIG. 2) and bottom end 78c (shown in FIG. 2) of bus bar 22c (shown in FIG. 2) may be inserted for securely holding bus bars 24a-b and bus bar 22c in place on the outer surface 38 (shown in FIG. 3) of upper cell stack panel 28. Outer surface 38 of upper cell stack panel 28 may include hooks 88a-c (shown in FIG. 3) which may be coupled to the bus bars via holes 90a-b (shown in FIG. 2) in bus bars 24a-b and hole 82c (shown in FIG. 2) of bus bar 22c for securely holding bus bars 24a-b and bus bar 22c in place on the outer surface 38 of upper cell stack panel 28.

In some embodiments, bus bars 22a-c may be nickel-plated steel, although bus bars 22a-c may be comprised of any suitably conductive material known in the art. In some embodiments, bus bars 24a-b may be copper and/or copper-plated, although bus bars 24a-b may be comprised of any suitably conductive material known in the art.

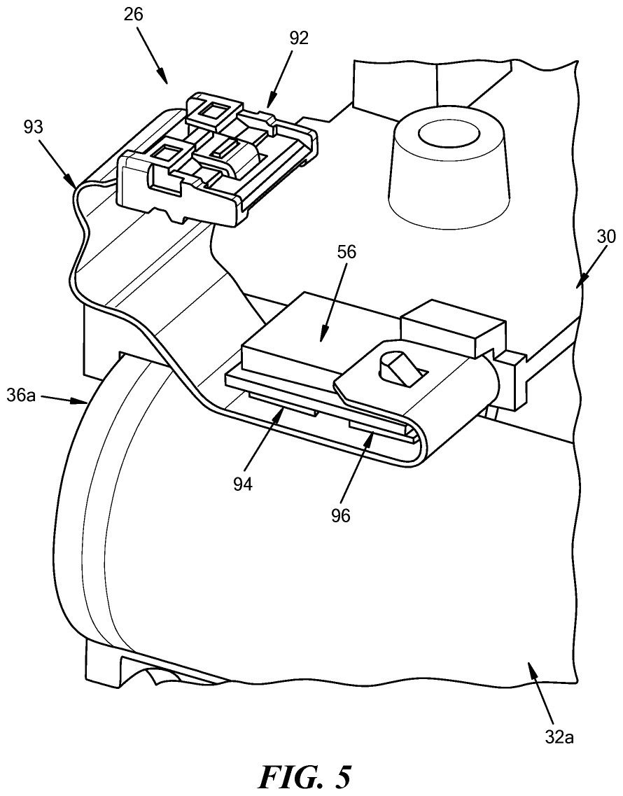

FIG. 5 is a cutaway perspective view of a portion of the battery cell stack 20, including battery cell 32a inserted into bottom cell stack cavity 36a of bottom cell stack panel 30. Temperature sensor 26 is shown inserted into receptacle 56, which may be a designated temperature sensor receptacle 56, for example. Temperature sensor 26 may include temperature sensor connector 92 for coupling with temperature sensor port 66 (shown in FIG. 4) of circuit board 62 (shown in FIG. 4), for transferring data and/or control signals and/or power between temperature sensor 26 and circuit board 62 and/or connector port 16 and/or BMU 18. Temperature sensor 26 may include body 93 which is shaped to fit into the temperature sensor receptacle 56. Temperature sensor may include foam pad 94 for providing a close contact with battery cell 32a, and/or for ensuring that sensor circuitry 96 is accurately reading the temperature of battery cell 32a, and/or for insulating the sensor circuitry 96 from temperature sensor receptacle 56. Foam pad 94, sensor circuitry 96, and/or temperature sensor connector 92 may be disposed on body 93.

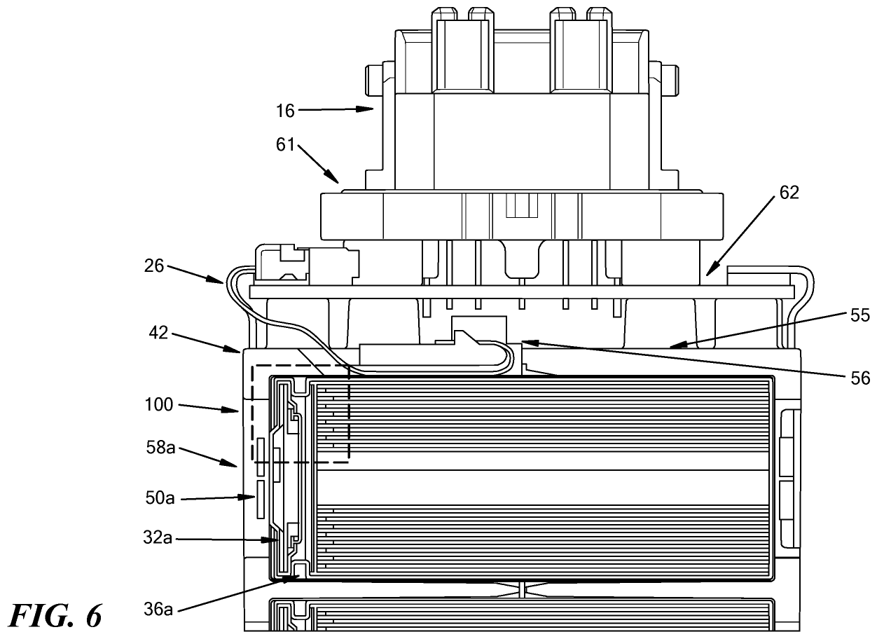

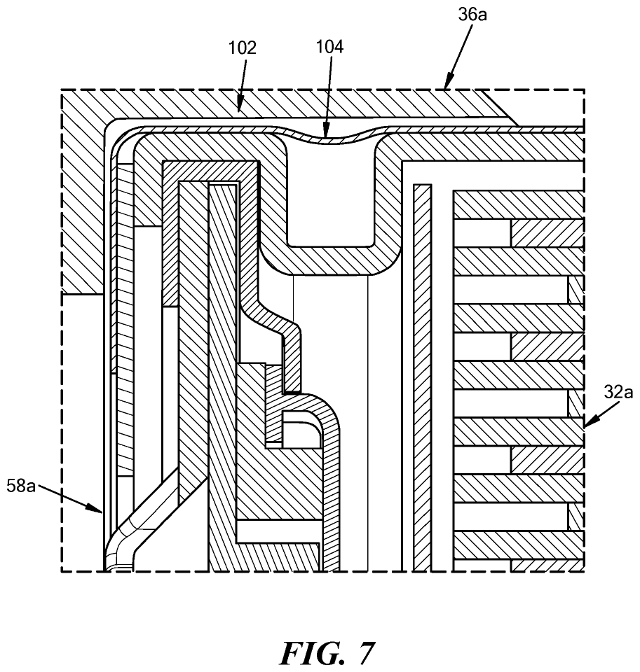

FIG. 6 is a cutaway perspective view of battery cell 32a inserted into combined cavity 46a formed by the coupling of cavity 34a of upper cell stack panel 28 and cavity 36a of bottom cell stack 30. Circuit board 62 is mounted on (top) surface 55. Temperature sensor 26 is inserted into receptacle 56 and affixed to circuit board 62. Connector port 16 is coupled to circuit board 62. Connector port 16 may include gasket 61. Positive terminal 58a of battery cell 32a is disposed adjacent to outer surface 42 and aperture 50a. Region 100 in FIG. 6, which is a subsection of the interface between battery cell 32a and an aperture 50a of outer surface 42, is depicted in greater detail in FIG. 7.

FIG. 7 is a close-up perspective view of region 100 of FIG. 6. The walls of structural element 102 in cavity 36a and positive terminal 58a of battery cell 32a forms venting cavity 104. By including venting cavity 104 in cavity 36a, rather than having the battery cell 32a be flush with structural element 102, battery cell 32a is able to vent and/or expand, thereby preventing undesirable buildup of heat and/or pressure. Similar structural elements 102 and venting cavities 104 may be included in some or all of cavities 34, cavities 36, and/or cavities 46.

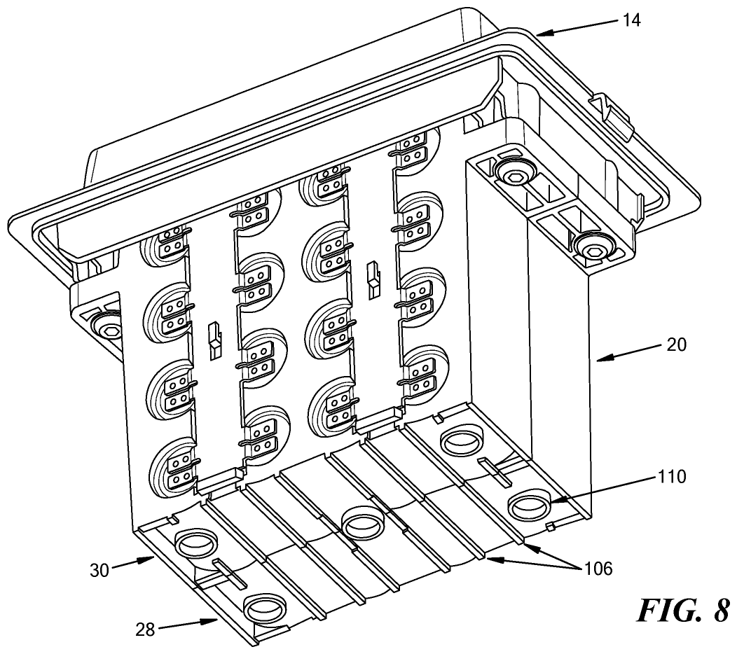

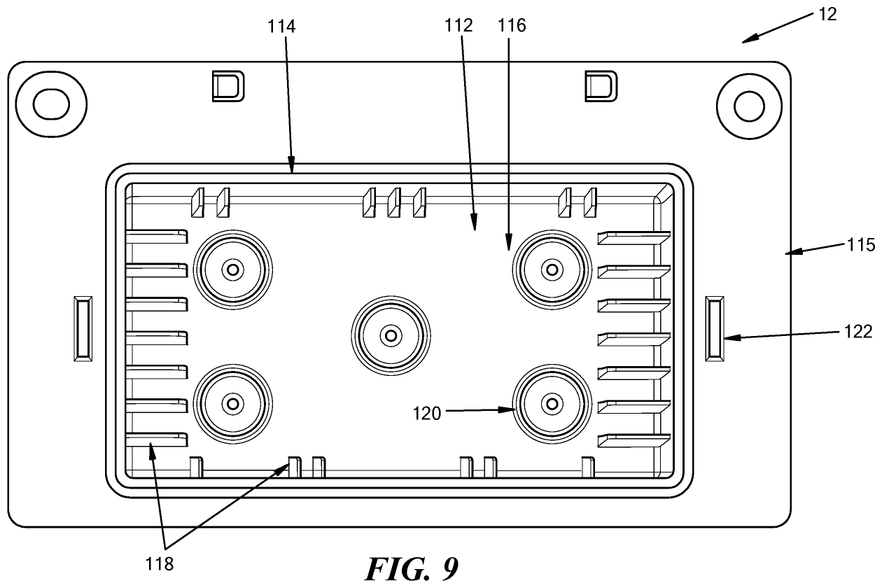

FIG. 8 is a perspective view of assembled battery cell stack 20 coupled to lid 14. The bottom surface 106 of cell stack 20 is formed by the coupling of the upper cell stack panel 28 and bottom cell stack panel 30. Bottom surface 106 may include rib features 108 and interlocking circular features 110 to aid securing of the battery cell stack 20 to the inner cavity 112 (FIG. 9) of battery housing 12. Although interlocking circular features 110 are described as circular, any shape may be used without deviating from the scope of the present disclosure.

FIG. 9 is a perspective view of battery housing 12. Battery housing 12 may include inner cavity 112 formed by the walls of the housing 12, and further includes rim 114 around the perimeter of the inner cavity 112 at the perpendicular interface of the walls forming inner cavity 112 and upper surface 115. The bottom surface 116 of cavity 112 may include guiding and holding ribs 118 and interlocking circular features 120, for coupling with rib features 108 and/or interlocking circular features 110 of bottom surface 106 of battery cell stack 20. Upper surface 115 may include slits 122 to aid in securing lid 14 to battery housing 12 such as via tabs on lid 14. Although interlocking circular features 120 are described as circular, any shape may be used without deviating from the scope of the present disclosure.

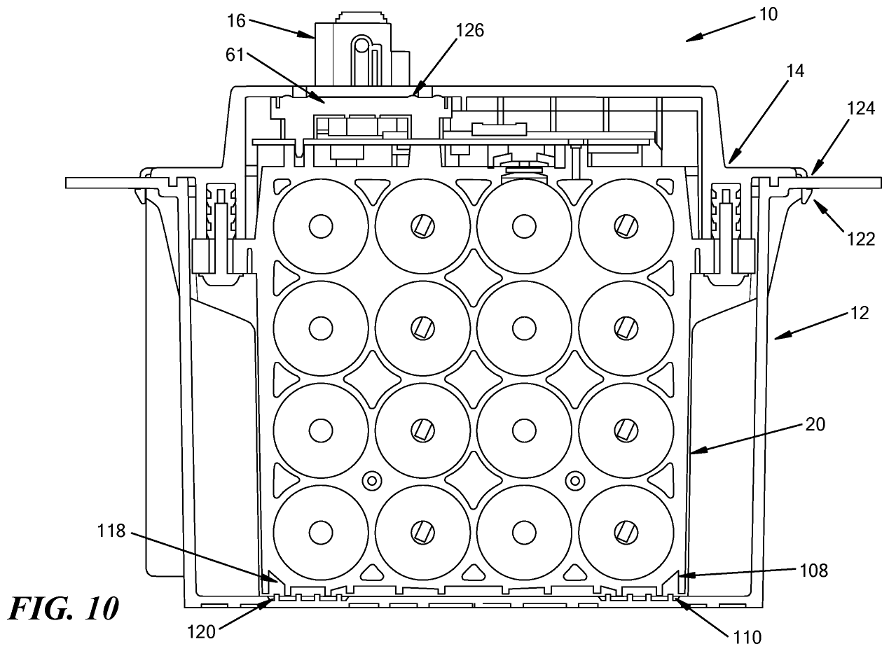

FIG. 10 is a cut-away view of the assembled battery assembly 10 with assembled battery cell stack 20 coupled to lid 14 and inserted into cavity 112 of battery housing 12. Tabs 124 of lid 14 may be inserted into slits 122 to aid in securing lid 14 to battery housing 12. Lid 14 is coupled to battery cell stack 20 such that gasket 61 of BMU connector port 16 forms a seal with inner surface 126 of top cover (i.e., lid) 14.

Still referring to FIG. 10, the rib features 108 of cell stack 20 may be secured to the guiding and holding ribs 118 of battery housing 12 using gap-filling epoxy 128 (although any suitable epoxy/adhesive may be used), and the interlocking circular features 110 of cell stack 20 may be coupled to interlocking circular features 120 of battery housing 12 using gap-filling epoxy 128 (although any suitable epoxy/adhesive may be used). Rim 114 of battery housing 12 is coupled to inner surface 126 of lid 14 using structural adhesive 130 (although any suitable epoxy/adhesive may be used).

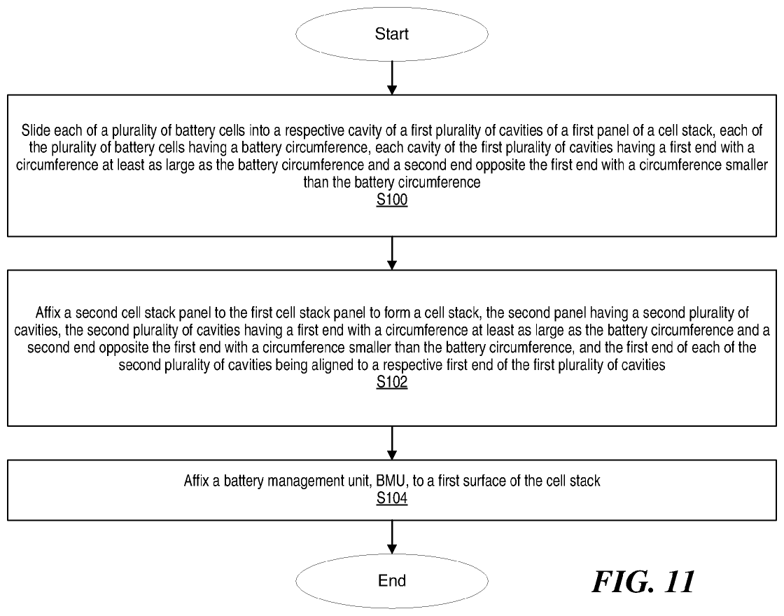

FIG. 11 is a flowchart of an example method of assembling battery assembly 10 according to one or more embodiments of the invention. One or more blocks described herein may be performed during manufacturing of the battery assembly 10. The manufacturing method includes sliding (Block S100) each of a plurality of battery cells 32 into a respective cavity 36a-p of a first plurality of cavities 36 of a first panel 30 (e.g., a bottom panel) of a cell stack 20, each of the plurality of battery cells 32a-p having a battery circumference, each cavity 36a-p of the first plurality of cavities 36 having a first end with a circumference at least as large as the battery circumference and a second end opposite the first end with a circumference smaller than the battery circumference. The method further includes affixing (Block S102) a second (e.g., upper) cell stack panel 28 to the first cell stack panel 30 to form a cell stack 20, the second cell stack panel 28 having a second plurality of cavities 34, each of the second plurality of cavities 34 having a first end with a circumference at least as large as the battery circumference and a second end opposite the first end with a circumference smaller than the battery circumference, and the first end of each of the second plurality of cavities 34 being aligned to a respective first end of the first plurality of cavities 36. The method further includes affixing (Block S104) a battery management unit, BMU, 18 to a first surface of the cell stack 20.

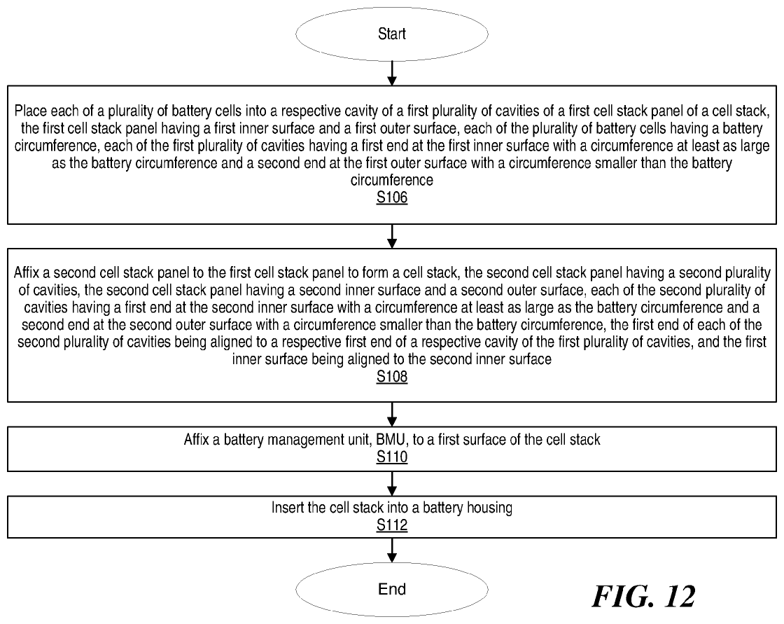

FIG. 12 is a flowchart of another example method of assembling battery assembly 10 according to one or more embodiments of the invention. One or more blocks described herein may be performed during manufacturing of the battery assembly 10. The method includes placing (Block S106) each of a plurality of battery cells 32 into a respective cavity 36 of a first plurality of cavities 36 of a first cell stack panel 30 of a cell stack 20, the first cell stack panel 30 having a first inner surface 44 and a first outer surface 42, each of the plurality of battery cells 32 having a battery circumference, each of the first plurality of cavities 36 having a first end at the first inner surface with a circumference at least as large as the battery circumference and a second end at the first outer surface 42 with a circumference smaller than the battery circumference. The method further includes affixing (Block S108) a second cell stack panel 28 to the first cell stack panel 30 to form a cell stack 20, the second cell stack panel 28 having a second plurality of cavities 34, the second cell stack panel 28 having a second inner surface 40 and a second outer surface 38, each of the second plurality of cavities 34 having a first end at the second inner surface 40 with a circumference at least as large as the battery circumference and a second end at the second outer surface 38 with a circumference smaller than the battery circumference, the first end of each of the second plurality of cavities 34 being aligned to a respective first end of a respective cavity 36 of the first plurality of cavities 36, and the first inner surface being aligned to the second inner surface. The method further includes affixing (Block S110) a battery management unit, BMU 18, to a first surface of the cell stack 20, and inserting (Block S112) the cell stack 20 into a battery housing 12.

According to one or more embodiments of this aspect, the method further includes applying an adhesive to a first plurality of interlocking features 120 of an inner surface 126 of a cavity of the battery housing 12, and inserting the cell stack 20 into the battery housing 12 such that a second surface of the cell stack 20 is aligned to the inner surface 126 of the cavity of the battery housing 12, the second surface of the cell stack 20 including a second plurality of interlocking features 110 aligned to the first plurality of interlocking features 120 using the adhesive, the adhesive being at least one of a gap-filling epoxy and a structural adhesive.

According to one or more embodiments of this aspect, the first plurality of interlocking features 120 includes at least one of guiding ribs and interlocking circular features, and the second plurality of interlocking features 110 includes at least one of guiding ribs and interlocking circular features.

According to one or more embodiments of this aspect, the method further includes affixing a first plurality of bus bars 22 to a surface of the first cell stack panel 30, each of the first plurality of bus bars 22 including a plurality of plates and a pad connector, affixing a second plurality of bus bars to a surface of the second cell stack panel 28, each of the second plurality of bus bars including a plurality of plates and a pad connector for each bus bar of the first plurality of bus bars, welding each of the plates of the bus bar to at least one of a positive terminal 58 and a negative terminal 60 of at least one of the plurality of battery cells 32 via the second end of a respective cavity 36 of the first plurality of cavities 36, for each bus bar 22 of the second plurality of bus bars 22, welding each of the plates of the bus bar 22 to at least one of a positive terminal 58 and a negative terminal 60 of at least one of the plurality of battery cells 32 via the second end of a respective cavity of the second plurality of cavities 34, for each bus bar 22 of the first plurality of bus bars 22, welding the pad connector of the bus bar to a respective pad of the BMU 18, and for each bus bar 22 of the second plurality of bus bars 22, welding the pad connector of the bus bar to a respective pad of the BMU 18.

According to one or more embodiments of this aspect, the method further includes affixing a lid 14 to the first surface of the cell stack 20, the lid 14 including an inner surface, an outer surface, and an aperture through the lid 14 from the outer surface to the inner surface, and coupling the inner surface of the lid 14 to a gasket 61 of a connector port disposed on the BMU 18, the gasket 61 being sized to seal the aperture when the connector port 16 is disposed through the aperture.

According to one or more embodiments of this aspect, the method further includes affixing the lid 14 to the battery housing 12 and to the cell stack 20.

According to one or more embodiments of this aspect, each of the plurality of battery cells 32 is a cylindrical battery cell 32 with a corresponding battery length, each of the first and second plurality of cavities 34, 36 being a cylindrical cavity of approximately half the corresponding battery length.

According to one or more embodiments of this aspect, each of the plurality of battery cells 32 is disposed perpendicularly to the first cell stack panel 30 and the second cell stack panel 28. Here, “perpendicularly” may be with respect to an axis which runs from the bottom surface 116 of the battery housing 12 to the lid/cover 14 where the BMU 18 may be situated.

According to one or more embodiments of this aspect, a first cavity 36a of the first plurality of cavities 36 includes a venting cavity/venting region 104 adjoining the first outer surface.

According to one or more embodiments of this aspect, the method further includes affixing a temperature sensor 26 to the battery assembly 10, the temperature sensor 26 including a first end and a second end, the first end being compressed against a first surface of a first battery cell 32 of the plurality of battery cells 32 and the second end being affixed to the BMU 18.

Some embodiments are described herein with reference to flowchart illustrations and/or block diagrams of methods and apparatuses. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments may not be limited to what may have been particularly shown and described herein above. In addition, unless mention was made above to the contrary, it should be noted that all of the accompanying drawings may be not to scale. A variety of modifications and variations may be possible in light of the above teachings without departing from the scope of the following claims.

1. A battery assembly comprising:
a battery housing including a housing cavity;
a cell stack disposed within the housing cavity, the cell stack including:
a first cell stack panel including a first inner surface and a first outer surface;
a second cell stack panel including a second inner surface and a second outer surface, the first cell stack panel and the second cell stack panel being coupled together at the respective first and second inner surfaces;
the coupled first cell stack panel and the second cell stack panel forming a plurality of cavities, each of the plurality of cavities extending from the first outer surface to the second outer surface; and
a plurality of battery cells, each of the plurality of battery cells being disposed within a respective cavity of the plurality of cavities.

2. The battery assembly of claim 1, wherein the battery assembly further comprises:
a plurality of bus bars, each bus bar of the plurality of bus bars being electrically coupled to at least one of a positive terminal and a negative terminal of at least one battery cell via at least one aperture in at least one of the first outer surface and the second outer surface.

3. The battery assembly of claim 1, wherein each of the plurality of battery cells is disposed perpendicularly to the first cell stack panel and the second cell stack panel.

4. The battery assembly of claim 1, wherein a first cavity of the plurality of cavities includes a venting region adjoining the first outer surface for venting a first battery cell of the plurality of battery cells.

5. The battery assembly of claim 1, wherein:
an inner bottom surface of the housing cavity includes a first plurality of interlocking features; and
a bottom surface of the cell stack includes a second plurality of interlocking features, the first plurality of interlocking features being coupled to the second plurality of interlocking features to aid in securing the cell stack to the housing cavity.

6. The battery assembly of claim 5, wherein the first plurality of interlocking features is coupled by an adhesive to the second plurality of interlocking features, the adhesive being at least one of: a gap-filling epoxy and a structural adhesive.

7. The battery assembly of claim 1, wherein the battery assembly further comprises:
a top cover including a top aperture and an inner surface; and
a battery management unit, BMU, affixed to a top surface of the cell stack, the BMU including:
a connector port for providing power to an external device; and
a gasket sealed to the inner surface of the top cover when the connector port is disposed through the top aperture.

8. The battery assembly of claim 7, wherein the battery assembly further comprises a temperature sensor, the temperature sensor including a first end and a second end, the first end being compressed against a first surface of a first battery cell of the plurality of battery cells and the second end being affixed to the BMU.

9. The battery assembly of claim 7, wherein the top cover is affixed to the battery housing and to the cell stack.

10. The battery assembly of claim 1, wherein each of the plurality of battery cells is a cylindrical battery cell, each of the plurality of battery cells having a battery circumference and a battery length, each of the plurality of cavities being a cylindrical cavity, each of the plurality of cavities having:
a first end at the first outer surface with a circumference smaller than the battery circumference;
a second end at the second outer surface with a circumference smaller than the battery circumference; and
a portion between the first outer surface and the second outer surface with a circumference at least as large as the battery circumference and with a length approximately equal to the battery length.

11. A method of manufacturing a battery assembly, the method comprising:
placing each of a plurality of battery cells into a respective cavity of a first plurality of cavities of a first cell stack panel of a cell stack, the first cell stack panel having a first inner surface and a first outer surface, each of the plurality of battery cells having a battery circumference, each of the first plurality of cavities having a first end at the first inner surface with a circumference at least as large as the battery circumference and a second end at the first outer surface with a circumference smaller than the battery circumference;
affixing a second cell stack panel to the first cell stack panel to form a cell stack, the second cell stack panel having a second plurality of cavities, the second cell stack panel having a second inner surface and a second outer surface, each of the second plurality of cavities having a first end at the second inner surface with a circumference at least as large as the battery circumference and a second end at the second outer surface with a circumference smaller than the battery circumference, the first end of each of the second plurality of cavities being aligned to a respective first end of a respective cavity of the first plurality of cavities, and the first inner surface being aligned to the second inner surface;
affixing a battery management unit, BMU, to a first surface of the cell stack; and
inserting the cell stack into a battery housing.

12. The method of claim 11, wherein the method further comprises:
applying an adhesive to a first plurality of interlocking features of an inner surface of a cavity of the battery housing; and
inserting the cell stack into the cavity of the battery housing such that a second surface of the cell stack is aligned to the inner surface of the cavity of the battery housing, the second surface of the cell stack including a second plurality of interlocking features aligned to the first plurality of interlocking features using the adhesive, the adhesive being at least one of a gap-filling epoxy and a structural adhesive.

13. The method of claim 12, wherein:
the first plurality of interlocking features includes at least one of guiding ribs and interlocking circular features; and
the second plurality of interlocking features includes at least one of guiding ribs and interlocking circular features.

14. The method of claim 11, wherein the method further comprises:
affixing a first plurality of bus bars to a surface of the first cell stack panel, each of the first plurality of bus bars including a plurality of plates and a pad connector;
affixing a second plurality of bus bars to a surface of the second cell stack panel, each of the second plurality of bus bars including a plurality of plates and a pad connector;
for each bus bar of the first plurality of bus bars, welding each of the plates of the bus bar to at least one of a positive terminal and a negative terminal of at least one of the plurality of battery cells via the second end of a respective cavity of the first plurality of cavities;
for each bus bar of the second plurality of bus bars, welding each of the plates of the bus bar to at least one of a positive terminal and a negative terminal of at least one of the plurality of battery cells via the second end of a respective cavity of the second plurality of cavities;
for each bus bar of the first plurality of bus bars, welding the pad connector of the bus bar to a respective pad of the BMU; and
for each bus bar of the second plurality of bus bars, welding the pad connector of the bus bar to a respective pad of the BMU.

15. The method of claim 11, wherein the method further comprises:
affixing a top cover to the first surface of the cell stack, the top cover including an inner surface, an outer surface, and an aperture through the top cover from the outer surface to the inner surface; and
coupling the inner surface of the top cover to a gasket of a connector port disposed on the BMU, the gasket being sized to seal the aperture when the connector port is disposed through the aperture.

16. The method of claim 15, wherein the method further comprises affixing the top cover to the battery housing and to the cell stack.

17. The method of claim 11, wherein each of the plurality of battery cells is a cylindrical battery cell with a corresponding battery length, each of the first and second plurality of cavities, being a cylindrical cavity of approximately half the corresponding battery length.

18. The method of claim 11, wherein each of the plurality of battery cells is disposed perpendicularly to the first cell stack panel and the second cell stack panel.

19. The method of claim 11, wherein a first cavity of the first plurality of cavities includes a venting region adjoining the first outer surface.

20. The method of claim 11, wherein the method further comprises affixing a temperature sensor to the battery assembly, the temperature sensor including a first end and a second end, the first end being compressed against a first surface of a first battery cell of the plurality of battery cells and the second end being affixed to the BMU.
